(19) United States
(12) Patent Application Publication
(10) Pub. No.: US 2007/0233835 A1
(43) Pub. Date: Oct. 4, 2007

(54) Methodology for scheduling data transfers from nodes using path information

(76) Inventors: Nandakishore Kushalnagar, Portland, OR (US); Jasmeet Chhabra, Hillsboro, OR (US); Mark Yarvis, Portland, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/395,730

(22) Filed: Mar. 31, 2006

(51) Int. Cl. G06F 15/173

(52) U.S. Cl. 709/223

(57) ABSTRACT

Wireless network communications utilizing routing information. A group of nodes of a wireless network are organized into one or more hierarchical clusters based, at least in part, on routing information corresponding to a path between a selected node and a cluster head node. A sleep state and an awake state are scheduled for each node in the cluster so that each node in the cluster transitions from a sleep state to an awake state at a selected time to receive transmissions from child nodes and to forward data the received data to a parent node and to transition to the sleep state, wherein the nodes of a cluster do not all transition from the sleep state to the awake state at substantially the same time.

### RELATED APPLICATIONS

The present application is related to the following U.S. Patent applications:

(1) application Ser. No. 11/006,843 filed Dec. 7, 2004 entitled, “APPARATUS, SYSTEM AND METHOD CAPABLE OF LOW DUTY CYCLE HIERARCHICAL AD HOC NETWORKS,” and

(2) application Ser. No. 11/050,997 filed Feb. 4, 2005 entitled, “APPARATUS, SYSTEM AND METHOD CAPABLE OF NODE ADAPTIVE SLEEP SCHEDULING IN WIRELESS AD HOC NETWORKS.”

### TECHNICAL FIELD

Embodiments of the invention relate to wireless communications. More particularly, embodiments of the invention relate to techniques and strategies for scheduling data transfer between nodes of a network using information related to paths between the nodes.

### BACKGROUND

Wireless communications has become prevalent throughout society creating the need for faster, more reliable and less power consuming wireless communication techniques. Included in wireless networks are networks such as, but not limited to, sensor networks. In networks such as sensor networks, network lifetime may be problematic, particularly when nodes are battery powered. A wireless sensor network may consist of battery-operated computing and sensing devices (nodes) that collaborate to deliver sensed data, often over multiple hops.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a conceptual illustration of one embodiment of a sensor network.

FIG. 2 is a timing diagram of one embodiment of a cluster sleep/wake coordination technique.

FIG. 3 is a block diagram of one embodiment of a cluster head.

FIG. 4 is a block diagram of one embodiment of a regular node.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

An example wireless sensor network may include battery-operated computing and sensing devices (nodes) that collaborate to deliver sensed data, often over multiple hops. Nodes of the sensor network may communicate using any wireless protocol. For example IEEE 802.11b/g/n and/or Bluetooth may be used. IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Related documents may include, for example, IEEE 802.11a. IEEE 802.11n is an addition to the 802.11 family of standards that is intended to increase wireless network speed and reliability. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

While network lifetime is a concern in sensor networks, communication patterns are typically sparse, and nodes may spend much of their time sleeping to save energy. Without the ability for nodes to sleep, the need to change batteries would increase the cost of maintaining a sensor network. A protocol that allows nodes to sleep may wake neighbors together to communicate without increasing latency or requiring buffering to deliver bulk data across multiple hops. However, to reduce energy consumption, nodes should only be awake when transmitting/forwarding data, receiving data, capturing data, or computing data.

Network operational availability is a primary concern in battery-powered sensor networks. Because many sensor networks experience significant periods of time without data traffic, network operational availability may be extended if one or more nodes periodically enter a sleep state to conserve battery power. Existing techniques that allow nodes to sleep and still communicate with neighboring nodes may utilize fine-grained, packet-level synchronization.

An alternative approach may be to utilize large-grained synchronization in which clusters of nodes synchronize sleep periods and utilize relatively long wake and sleep periods. As described in greater detail below, a combination of route selection and course-grained, application-level synchronized sleep/wake transitions, dynamically defining clusters of nodes that sleep and wake may allow improved battery life. Specifically, the techniques described herein may allow for relatively long sleep periods and relatively low synchronization overhead, which may result in increase of sensor battery life.

Each cluster may have a cluster head that may impose a duty cycle on the cluster, sending a periodic beacon while the cluster is awake to communicate to the nodes within the cluster when to start sleeping and how long to sleep. While the beacon may specifies a sleep/wake cycle, it may also be used to update the “wake time,” either lengthening or shortening a given wake period. This technique may require the system to predict an amount of time required to complete a data transfer, during which the cluster must stay awake. Also nodes that miss the beacon may remain awake. In one embodiment, all nodes in the cluster may be awake when the cluster is awake, even if they are not generating or forwarding data.

Techniques described herein may be useful in a network having battery-powered sensors having one or more of the following characteristics: (1) relatively sparse communication patterns; (2) one-to-many or many-to-one communications; (3) utilize an ad hoc wireless topology; and/or (4) include multiple points of exit to a backbone network. Networks having these characteristics may be used, for example, for building automation or monitoring/control of industrial equipment. Nodes in these networks may have relatively low duty cycles (possibly less than 1%).

A network may include three types of nodes: (1) regular nodes; (2) sinks; and (3) cluster heads. Regular nodes may be power constrained (e.g., battery powered) and may use short-range radios as part of an ad hoc wireless network. Sink nodes may be the focus of many-to-one or one-to-many communication with regular nodes. Any number of sinks may be included in a network. Cluster heads are typically less power constrained (e.g., have access to line power or longer-life battery power) than regular nodes. Cluster heads may interface with a backbone network that may allow cluster heads to interact with each other and/or other networks.

In one embodiment, a proactive distance-vector-based routing algorithm may be used to route packets from the regular nodes to each sink node. Other routing algorithms may also be used. Each sink node may send periodic route updates that propagate through the network. Typically, route updates include metrics, such as hop count or end-to-end reliability, allowing nodes to select the “best” path to the sink. Each node may track the “next hop” that optimizes the metric. Packets originating or forwarded by this node to a given sink may be sent to this next hop.

Route updates may also propagate across the backbone network to cluster heads. Cluster heads that are far from the sink node will likely be able to advertise a favorable metric in their route update, attracting neighbors to establish routes through this cluster head. Thus, nodes in the neighborhood of a cluster head (even those multiple hops away) tend to forward packets through that cluster head.

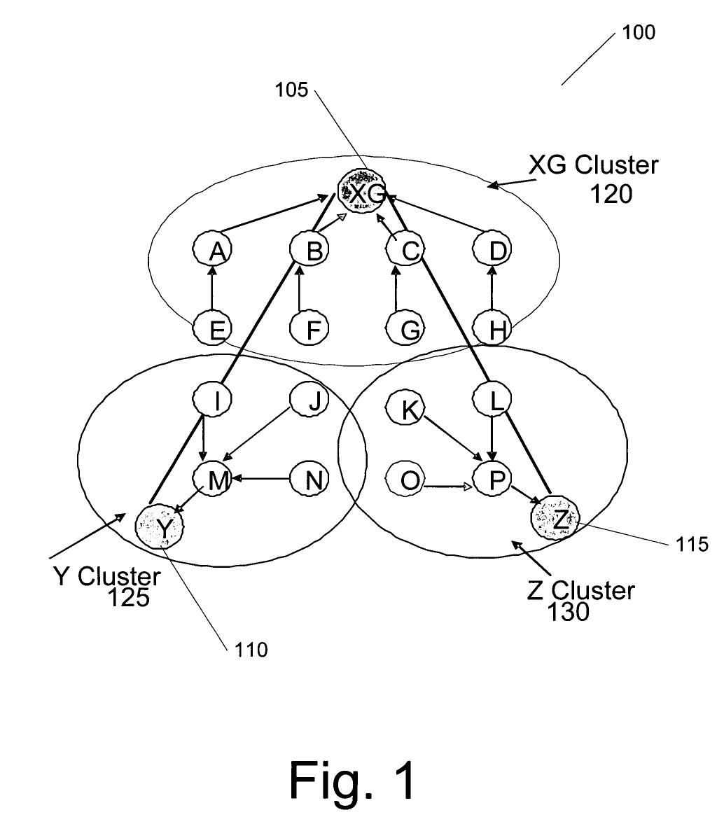

Routing information obtained, for example, by analysis of route update messages may be used to arrange sleep/wake schedules such that a node is not awake unless it is required to originate and/or forward data, which may reduce the overall number of sleep/wake transitions as compared to a duty cycle approach. FIG. 1 illustrates a conceptual diagram of one embodiment of a sensor network. In the example of FIG. 1, nodes XG, Y and Z are cluster heads. Apart from being a cluster head, node XG may also function as a gateway node. The gateway node may be responsible for interfacing with the desired application and thus act as a sink for the network.

Cluster heads may have a high-bandwidth and highly reliable link to the gateway node. Both cluster head nodes and the gateway node may have an infinite source of power (e.g., wall power). The cluster head may use routing metrics to attract nearby nodes to route data through the cluster head, creating virtual multi-hop clusters of nodes. Nodes may determine to which cluster they belong from a tag in their selected route update packet. Unlike a simple protocol in which all nodes in the cluster are simultaneously awake, techniques described herein may allow a sleep wake schedule that is tied to a schedule of data transfers. The following is an illustration one version of these techniques, however, it is understood it is but one of many possible versions.

Phase 1 may be the routing phase wherein when nodes wake up, they form routes to a destination. In the following example, the destination is to XG 105. Popular routing protocols such as Destination Sequenced Distance Vector (DSDV), Ad hoc On Demand Distance Vector (AODV) may be utilized to create such routes. Nodes Y 110 and Z 115 may have better connectivity to XG 105 and may have an infinite source of energy. These nodes advertise better routing metrics thus making them more attractive to other nodes. Such nodes may form cluster heads.

Phase 2 may be the cluster head discovery phase. Within the routing information, cluster heads may also indicate the cluster head address. As a node determines its route to the cluster head (using Phase 1), the cluster to which the node belongs may be determined. Once a node identifies its cluster, the node may ignore any message (including route update messages) that is not from its cluster head. One way for a node to select a cluster head would be to use the first cluster head that a node receives a message from, although other techniques may be used. This may be done in order to make sure that other cluster heads do not send messages that impact nodes within some other clusters. Like the routing phase, the discovery phase may also go on through out the wake period.

Phase 3 may be a node discovery phase. After the nodes identify their cluster heads, nodes within the cluster may identify themselves to the cluster head by sending trace route messages to the cluster head. The trace route messages may indicate the chosen cluster head. The trace route message may also indicate the path the packet took (e.g., an ordered list of nodes through which the packet was forwarded) to deliver the packet through the network. The chosen cluster head may wait for a certain period of time during which it may receive information about nodes within the cluster. If a network includes sensors as well as routers, nodes may also add type information to the trace route packet. This may enable the cluster head to schedule data from nodes that are sensor nodes and router nodes.

Phase 4 may be a data scheduling and transfer phase wherein the cluster head may initiate a data scheduling process and the cluster head may schedule data transfer from nodes within its cluster. Because the routes conceptually form a tree, cluster heads may use the trace route messages from Phase 3 to construct a spanning tree representation of the routing paths to nodes in the cluster. Creation of the spanning tree may be performed in any manner known in the art.

A schedule of start times for data transfers from each node may be computed, for example, by performing a post-order traversal of the spanning tree representation of the routes. Each node may be scheduled to start its data transfer in sequence with sibling nodes after its child nodes. Although it may not always be possible to predict an exact time for a node to complete a data transfer, estimations may be used to provide sufficient transmission timing coordination. For example, a predicted transmission duration may be based on a history of transmissions from the node. A cluster head may also estimate the transmission duration by multiplying the maximum time needed for a node to transfer data across a single hop by the number of hops on a route.

The cluster head may then transmit a schedule request beacon message to each node in a cluster. The data schedule beacon may indicate a time during which a node should wake to transmit data. In one embodiment, upon receiving the data schedule request beacon message a node may respond by sending an acknowledgement message to the sending node adding timing information within the beacon payload.

Beacon messages may be delivered from a cluster head to cluster member nodes by forwarding the messages along the data delivery tree. As the beacon message progresses toward the destination node, intermediate nodes that forward the beacon gather timing information related to child nodes. The intermediate nodes may use this information to, for example, wake at the beginning of a transfer from a child node for the duration of the transmission and to forward the data. The intermediate node may then go to sleep. Because the schedule represents a post-order traversal of the network, the parent node may wake up before the first transmission of any node in the subtree and go to sleep after its own transmission. This may be beneficial, for example, if storage space on the node is limited or if the cost of sleep/wake transitions is relatively high.

Phase 5 may be the sleep phase wherein once the cluster head completes the data scheduling process of all nodes within the cluster, the cluster head may send a beacon indicating the sleep duration for the cluster and time until sleep. Sending the beacon at the end may ensure that the node stays awake for enough time for the data scheduling to finish. Furthermore it may ensure that all nodes are synchronized with a single beacon instead of multiple beacon updates. The beacon may be sent multiple times with decreasing “time until sleep” to make sure that all nodes within the cluster receive them, although the present invention is not limited in this respect.

Phase 6 may be the data transfer phase. At the time determined in Phase 4, each node may wake up and forward data. At the time specified in the schedule, the node may begin data transfer. Because each node along the path to the cluster head should be awake, the data should reach the destination with little delay. After the data transfer is completed, a node may send an acknowledgement message to the cluster head to indicate completion and then may transition to sleep until the next scheduled wake period.

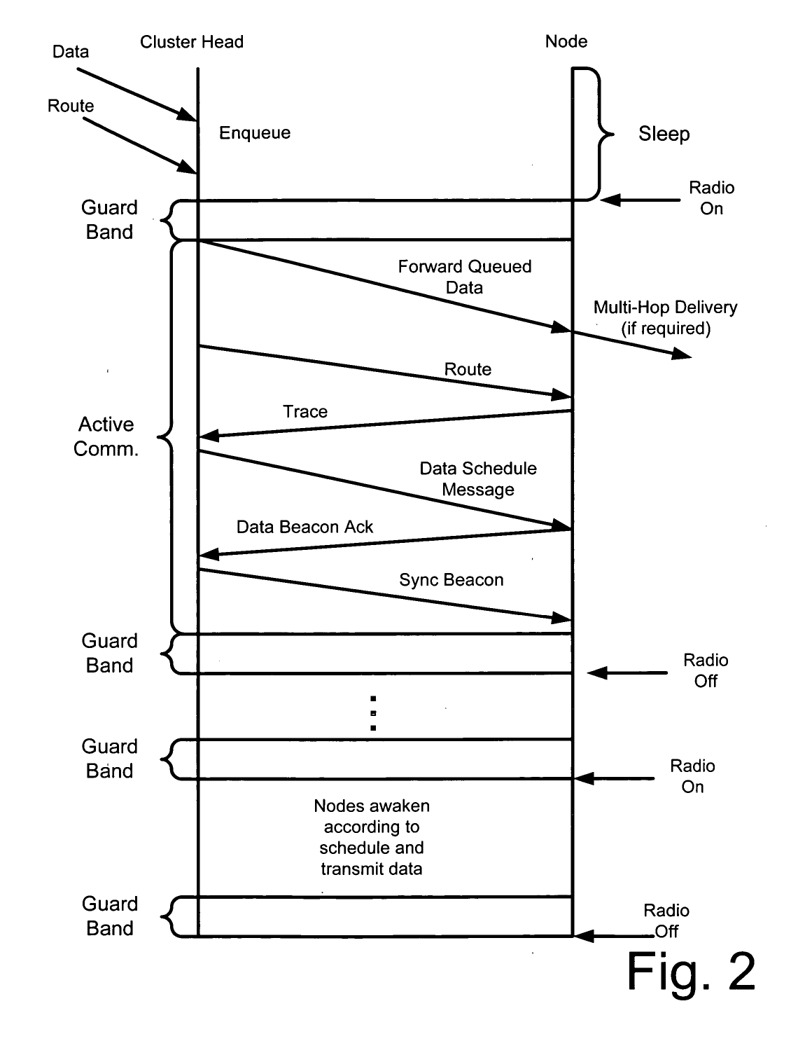

FIG. 2 is a timing diagram of one embodiment of a cluster sleep/wake coordination technique. When nodes are asleep, a cluster head may queue data packets including, for example, route updates. One or more nodes of the cluster may wake at a predetermined time as specified in a previous communication by the cluster head.

When nodes become active, the cluster head may forward queued data to the nodes via multi-hop delivery, if necessary. Route updates, forwarding of incoming packets, return of data packets from cluster node to cluster head, beacon transmissions may be accomplished via contention-based, unscheduled and unordered communications. Other communications techniques may also be used.

The following four characteristics may be supported by sleep/wake scheduling. A guard band may be used to handle loss of synchronization between nodes. During the guard band period, nodes may listen for transmission from neighboring nodes but not originate or forward data. The length of the guard band may be selected based on, for example, distribution latency of node sleep commands from the cluster head and maximum clock drift that may occur while nodes are sleeping.

After the guard band period, the cluster heads may forward packets that were queued from the cluster members during the sleep period. The length of this period may be fixed or the cluster head may send a message to indicate the end of this period.

The longest period of the wake cycle may be, but is not required to be, the active communication phase. During this phase individual nodes may send packets to the sink node. As described above, nodes may transition to a sleep state after transmitting data originating from the node and after forwarding data from all child nodes. The cluster head may also forward packets to nodes from the sink including, for example, route update messages that may propagate through the cluster.

A guard band may also be utilized at the end of the wake period. During this time the nodes may receive packets and forward packets toward the cluster head, but not originate packets. At the conclusion of the guard band the node may transition to the sleep state and remain in the sleep state until the next scheduled transmission period as communicated from the cluster head and based on the routing information as described above.

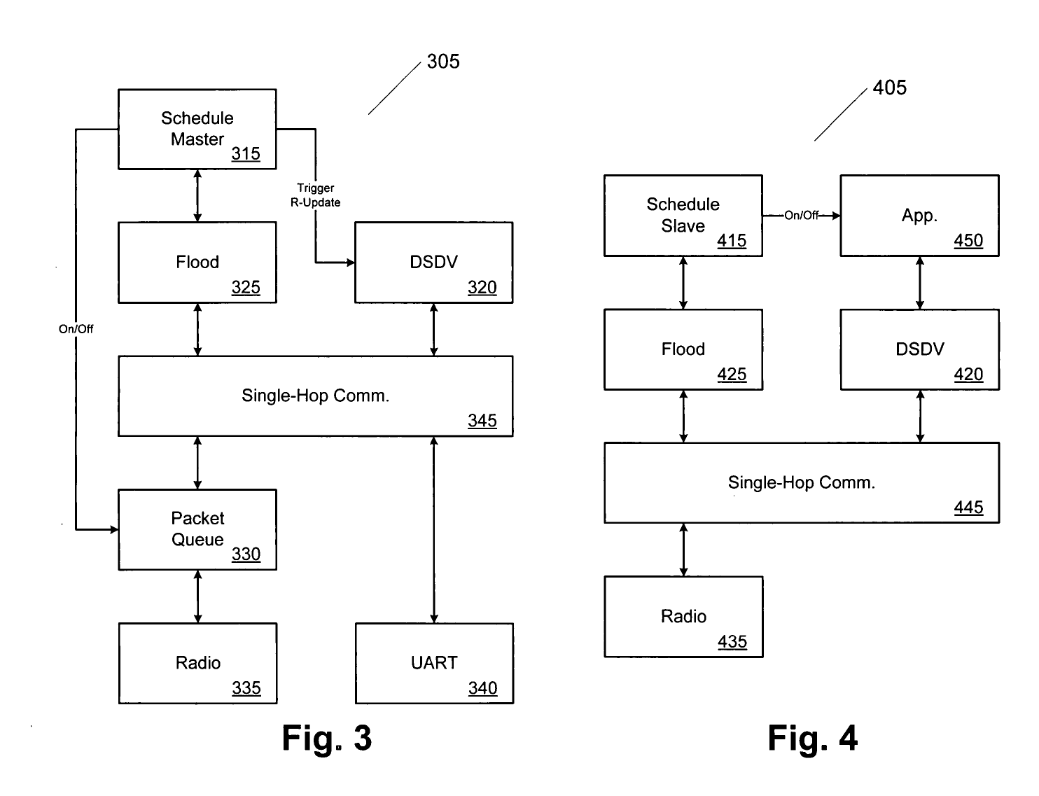

The cluster sleep/wake protocol may be implemented in the cluster head and the regular nodes. FIG. 3 is a block diagram of one embodiment of a cluster head. The various modules of cluster head 305 may be implemented as hardware, software, firmware or any combination thereof. One or more of the modules of cluster head 305 may include a computer-readable medium (e.g., dynamic random access memory, read-only memory, flash memory, removable storage media) to store instructions that may be executed by processing and/or control circuitry within the module. Cluster head 305 may include schedule master module 315 that may implement the cluster head part of the sleep/wake mechanisms as described herein.

When entering the sleep mode, schedule master module 315 may send an “on” signal to packet queue module 330. As a result packet queue module 330 may queue any packets received for transmission from single hop communications module 345 and radio module 335 may be powered off. During this time packets from the overlay network may be received via a secondary communications interface, for example, universal asynchronous receiver/transmitter (UART) module 340, or any other type of interface. Such packets may be processed by single hop communications module 345, processed by a routing layer, for example, DSDV module 320 and forwarded back through single hop communications module 345 to packet queue module 330 where they may be queued.

At a future time, schedule master module 315 may switch to wake mode. At the start of the wake mode, schedule master module 315 may send an “off” signal to packet queue module 330, which may cause radio module 335 to be turned on and queued packets to be transmitted via radio module 335.

Schedule master module 315 may then signal the routing layer (e.g., DSDV module 320) to send route updates to identify new routes. In this mode, packets receive from the sensor network via radio module 335 may traverse packet queue module 330 to single hop communications module 345 to DSDV module 320 back through single hop communications module 345 and to the overlay network via UART module 340.

Packets received from the overlay network may take the reverse path, eventually being delivered to the sensor network via radio module 335. In addition, schedule master module 315 may generate beacon packets and cause the beacon packets to be delivered to the sensor network via flood module 325. At an appropriate time, schedule master module 315 may switch back to sleep mode as described above.

FIG. 4 is a block diagram of one embodiment of a regular node. The various modules of regular node 405 may be implemented as hardware, software, firmware or any combination thereof. One or more of the modules of regular node 405 may include a computer-readable medium (e.g., dynamic random access memory, read-only memory, flash memory, removable storage media) to store instructions that may be executed by processing and/or control circuitry within the module. Regular node 405 may include schedule slave module 415 that may implement the node portion of the sleep/wake mechanisms as described herein. While in the awake mode, schedule slave module 415 may receive beacon packets form the sensor network through radio module 435, single hop communications module 445 and flood module 425. Regular node 405 may originate packets of data and/or forward packets of data received from child nodes in the awake state. In one embodiment, upon completion of transmission of originated packets and/or forwarded packets, regular node 405 may transition to the sleep state.

Packets may be sent to and from the sensor network by application module 450 through routing layer, for example DSDV module 420, single hop communications module 445 and radio module 435. At some time, schedule slave module 415 may switch to the sleep mode in accordance with received beacon messages and/or other information as described herein, and signal application module 450 to transition to the sleep state. Application module 450 may then cease generating packets.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
organizing a group of nodes of a wireless network into one or more hierarchical clusters based, at least in part, on routing information corresponding to a path between a selected node and a cluster head node;
scheduling a sleep state and an awake state for each node in the cluster so that each node in the cluster transitions from a sleep state to an awake state at a selected time to receive transmissions from child nodes and to forward data the received data to a parent node and to transition to the sleep state, wherein the nodes of a cluster do not all transition from the sleep state to the awake state at substantially the same time.

2. The method of claim 1 wherein scheduling the sleep state and the awake state for each node in a cluster comprises:
sending route update messages from the cluster head to each node;
receiving cluster discovery messages from nodes in the cluster;
receiving a schedule created by one or more nodes in the cluster for the cluster and sending the schedule to each cluster member;
one or more nodes in the cluster selecting a time to transition from the sleep state to the awake state based on information in one or more schedule messages.

3. The method of claim 1 wherein scheduling the sleep state and the awake state for each node in a cluster comprises:
generating a spanning tree representation of nodes in the cluster;
performing a post-order traversal of the spanning tree representation to schedule start times for data transfers from each node represented in the spanning tree.

4. The method of claim 3 wherein each node is scheduled to start its data transfer in sequence with sibling nodes after its child nodes.

5. The method of claim 1 wherein the awake state comprises:
a guard band time period;
a cluster head forwarding period during which the cluster head forwards packets that were queued for the cluster nodes during the sleep state;
an active communication time period;
a synchronization period during which the cluster head sends synchronization information to one or more cluster nodes.

6. One or more computer-readable media having stored thereon storing instructions that, when executed, cause one or more processing circuits to:
organize a group of nodes of a wireless network into one or more hierarchical clusters based, at least in part, on routing information corresponding to a path between a selected node and a cluster head node;
schedule a sleep state and an awake state for each node in the cluster so that each node in the cluster transitions from a sleep state to an awake state at a selected time to receive transmissions from child nodes and to forward data the received data to a parent node and to transition to the sleep state, wherein the nodes of a cluster do not all transition from the sleep state to the awake state at substantially the same time.

7. The computer-readable media of claim 6 wherein the instructions that cause the one or more processing circuits to schedule the sleep state and the awake state for each node in a cluster comprise instructions that, when executed, cause the one or more processing circuits to:
send route update messages from the cluster head to each node;
receive cluster discovery messages from nodes in the cluster;
receive a schedule created by one or more nodes in the cluster for the cluster and sending the schedule to each cluster member;
one or more nodes in the cluster select a time to transition from the sleep state to the awake state based on information in one or more schedule messages received from respective child nodes.

8. The computer-readable media of claim 6 wherein the instructions that cause the one or more processing circuits to schedule the sleep state and the awake state for each node in a cluster comprise instructions that, when executed, cause the one or more processing circuits to:
generate a spanning tree representation of nodes in the cluster;
perform a post-order traversal of the spanning tree representation to schedule start times for data transfers from each node represented in the spanning tree.

9. The computer-readable media of claim 8 wherein each node is scheduled to start its data transfer in sequence with sibling nodes after its child nodes.

10. The computer-readable media of claim 6 wherein the awake state comprises:
a guard band time period;
a cluster head forwarding period during which the cluster head forwards packets that were queued for the cluster nodes during the sleep state;
an active communication time period;
a synchronization period during which the cluster head sends synchronization information to one or more cluster nodes.

11. A wireless network comprising:
a plurality of nodes interconnected via wireless communications links organized as one or more hierarchical clusters based, at least in part, on routing information corresponding to a path between a selected node and a cluster head node, the nodes of a cluster to schedule a sleep state and an awake state for each node in the cluster so that each node in the cluster transitions from a sleep state to an awake state at a selected time to receive transmissions from child nodes and to forward data the received data to a parent node and to transition to the sleep state, wherein the nodes of a cluster do not all transition from the sleep state to the awake state at substantially the same time.

12. The wireless network of claim 11 wherein scheduling the sleep state and the awake state for each node in a cluster comprises sending route update messages from the cluster head to each node, receiving cluster discovery messages from nodes in the cluster, receiving a schedule created by one or more nodes in the cluster for the cluster and sending the schedule to each cluster member, and one or more nodes in the cluster selecting a time to transition from the sleep state to the awake state based on information in one or more schedule messages.

13. The wireless network of claim 11 wherein scheduling the sleep state and the awake state for each node in a cluster comprises generating a spanning tree representation of nodes in the cluster and performing a post-order traversal of the spanning tree representation to schedule start times for data transfers from each node represented in the spanning tree.

14. The wireless network of claim 13 wherein each node is scheduled to start its data transfer in sequence with sibling nodes after its child nodes.

15. The wireless network of claim 11 wherein the awake state comprises a guard band time period, a cluster head forwarding period during which the cluster head forwards packets that were queued for the cluster nodes during the sleep state, an active communication time period, a synchronization period during which the cluster head sends synchronization information to one or more cluster nodes.

16. A wireless system comprising:
a plurality of nodes each having a processor, a dynamic random access memory coupled to the processor at an antenna coupled with the processor, the nodes interconnected via wireless communications links organized as one or more hierarchical clusters based, at least in part, on routing information corresponding to a path between a selected node and a cluster head node, the nodes of a cluster to schedule a sleep state and an awake state for each node in the cluster so that each node in the cluster transitions from a sleep state to an awake state at a selected time to receive transmissions from child nodes and to forward data the received data to a parent node and to transition to the sleep state, wherein the nodes of a cluster do not all transition from the sleep state to the awake state at substantially the same time.

17. The wireless system of claim 16 wherein scheduling the sleep state and the awake state for each node in a cluster comprises sending route update messages from the cluster head to each node, receiving cluster discovery messages from nodes in the cluster, receiving a schedule created by one or more nodes in the cluster for the cluster and sending the schedule to each cluster member, and one or more nodes in the cluster selecting a time to transition from the sleep state to the awake state based on information in one or more schedule messages.

18. The wireless system of claim 16 wherein scheduling the sleep state and the awake state for each node in a cluster comprises generating a spanning tree representation of nodes in the cluster and performing a post-order traversal of the spanning tree representation to schedule start times for data transfers from each node represented in the spanning tree.

19. The wireless system of claim 18 wherein each node is scheduled to start its data transfer in sequence with sibling nodes after its child nodes.

20. The wireless system of claim 16 wherein the awake state comprises a guard band time period, a cluster head forwarding period during which the cluster head forwards packets that were queued for the cluster nodes during the sleep state, an active communication time period, a synchronization period during which the cluster head sends synchronization information to one or more cluster nodes.
